(19) United States
(12) Patent Application Publication
(10) Pub. No.: US 2007/0180155 A1
(43) Pub. Date: Aug. 2, 2007

(54) Method and apparatus for implementing transfer ordering using hardware linked list

(75) Inventor: John David Irish, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/344,905

(22) Filed: Feb. 1, 2006

(51) Int. Cl. G06F 3/00

(52) U.S. Cl. 710/5

(57) ABSTRACT

A method and apparatus are provided for implementing transfer ordering in a processor input/output (I/O) interface. A pointer field is added to a command buffer. Commands are chained together in a linked list defining the transfer ordering. A currently executing command, or a command whose data is currently being transferred is held in a current execution register. The current execution register includes a pointer to the next command to be executed, or data to be transferred. When the current command completes, the pointer is used to fetch information for a next command. A command that last received an ordering event is held in a last received register. The last received register contains a link pointer field, which initially is not valid. When the next ordering event occurs, the link pointer field is loaded with a pointer to the command corresponding to the new ordering event. The register information is then written to the command buffer.

### FIELD OF THE INVENTION

The present invention relates generally to the data processing field, and more particularly, relates to a method and apparatus for implementing transfer ordering in a processor input/output (I/O) interface.

### DESCRIPTION OF THE RELATED ART

IO interfaces commonly require command and data transfers to be ordered in certain ways. For example, PCI, PCI-X and PCI-Express interfaces require Produce/Consumer Strong Ordering rules to be followed. Another possibility is a clustered processor ordering rule that requires data for write commands to be sent over the IO interface in the same order that the destination chip acknowledged the write commands. Under certain circumstances it may be necessary for a chip attached to an IO interface to store the ordering information for every write it has outstanding.

A known solution for keeping the ordering information required on IO interfaces is to use a FIFO to hold the commands or in the clustered processor write case, the acknowledgement responses. If the number of outstanding commands can be large, for example, 64, an order FIFO would require the addition of an array to the design as well as the necessary latches for pointers and empty/full indicators.

Another possibility is to maintain the FIFO data in the command buffer along with such information as data transfer length, response status, and the like. The disadvantage of this approach is that maintaining the order FIFO requires extra bandwidth on the command buffer's read and write ports possibly requiring additional ports to be added to the command buffer.

A need exists for an effective and efficient mechanism that maintains the ordering information required on 10 interfaces and that does not require adding cell area for arrays or additional array read/write ports.

### SUMMARY OF THE INVENTION

A principal aspect of the present invention is to provide a method and apparatus for implementing transfer ordering in a processor input/output (I/O) interface. Other important aspects of the present invention are to provide such method and apparatus for implementing transfer ordering in a processor input/output (I/O) interface substantially without negative effect and that overcome many of the disadvantages of prior art arrangements.

In brief, a method and apparatus are provided for implementing transfer ordering in a processor input/output (I/O) interface. A pointer field is added to a command buffer. Commands are chained together in a linked list defining the transfer ordering. A currently executing command, or a command whose data is currently being transferred is held in a current execution register. The current execution register includes a pointer to the next command to be executed, or data to be transferred. When the current command completes, the pointer is used to fetch information for a next command. A command that last received an ordering event is held in a last received register. The last received register contains a link pointer field, which initially is not valid. When the next ordering event occurs, the link pointer field is loaded with a pointer to the command corresponding to the new ordering event.

In accordance with features of the invention, when the next ordering event occurs the last received register information is then written to the command buffer. The information in this write includes the pointer as well as the indicator that the ordering event for this command has occurred. This means that writing the linked list pointer to the command buffer or command status buffer does not add any extra writes to either of these structures. The write would have occurred anyway to update the status indicator. The new command is then saved in the last received register.

In accordance with features of the invention, when the ordering linked list is empty and the current execution register is empty when an ordering event occurs, the command corresponding to the ordering event is moved directly to the current execution register and no link is created.

In accordance with features of the invention, when the ordering linked list is empty and the current execution register contains a valid command when an ordering event occurs, the command corresponding to the ordering event is stored in the last received register. The pointer field in the current execution register is updated to point to the command in the last received register.

In accordance with features of the invention, when the current execution register's pointer is pointing to the command in the last received register when the current execution register's command or data transfer completes, the command from the last received register is moved directly to the current execution register.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a high-level system diagram illustrating an exemplary system for implementing transfer ordering in a processor input/output (I/O) interface in accordance with the preferred embodiment;

FIG. 2 is a block diagram illustrating exemplary apparatus for transfer ordering in the processor input/output (I/O) interface of FIG. 1 including a linked list with a command buffer in accordance with the preferred embodiment;

FIG. 3 is a block diagram illustrating another exemplary apparatus for transfer ordering in the processor input/output (I/O) interface of FIG. 1 including a linked list with a command status buffer in accordance with the preferred embodiment;

FIGS. 4A and 4B are diagrams illustrating exemplary operations and changes in the linked list with the command status buffer of FIG. 3 when a write command data transfer completes in accordance with the preferred embodiment; and

FIGS. 5A, 5B, 5C and 5D are diagrams illustrating exemplary operations and changes in the linked list with the command status buffer of FIG. 3 when responses arrive for write commands, and responses are held in a write response register in accordance with the preferred embodiment.

### DETAILED DESCRIPTION OF THE PREFERRED EMBODIMENTS

In accordance with features of the invention, a method is provided of keeping command ordering information that is different than the order in which commands arrived at the IO interface logic inputs, such as in the clustered processor write data ordering case. The method uses a linked list where the list pointers are stored with each command in the command buffer or in a command status buffer if it is kept separately from the main command buffer. A significant advantage is that the list pointers advantageously are maintained using buffer reads and writes that are already being done to process the command or data transfer. The list pointers are written at the same time and to the same buffer address as command status is written. The list pointers are read at the same time commands are read to be sent to the IO interface or to direct the sending of data to the IO interface.

In accordance with features of the invention, a pointer field is added to the command buffer or to the command status information if the command status information is kept in an array separately from the command buffer. A required transfer order is indicated by chaining the commands together in a linked list. The invention requires the addition of one register to the array write port data register and read port data register that would normally be present. The additional register is necessary to hold command information until the next command that must be handled in order is known. When the next command is known, the list pointer in the new register can be updated and the entire register contents can then be written to the command array.

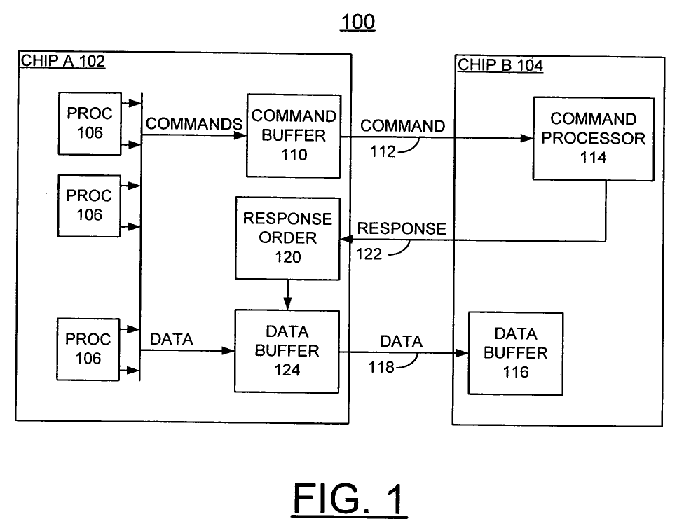

Having reference now to the drawings, in FIG. 1, there is shown an exemplary system generally designated by the reference character 100 in accordance with the preferred embodiment. System 100 includes a first chip A, 102 and a second chip B, 104.

First chip A, 102 includes a plurality of processors 106 sending commands and data to the second chip B, 104. Commands are placed in a command buffer 110 and are sent to the second chip B, 104 in the order that the commands are placed in the command buffer 110 via a communications link 112.

Second chip B, 104 includes command processing logic 114 for receiving commands from the communications link 112 and a data buffer 116 for receiving data via a communications link 118.

Command processing logic 114 of second chip B, 104 sends responses to a response order block 120 of first chip A, 102 via a communications link 122. First chip A, 102 includes a data buffer 124 and sends data to the second chip B, 104. The data must be sent to the second chip B, 104 in the order that the second chip B, 104 responds to the commands from the first chip A, 102.

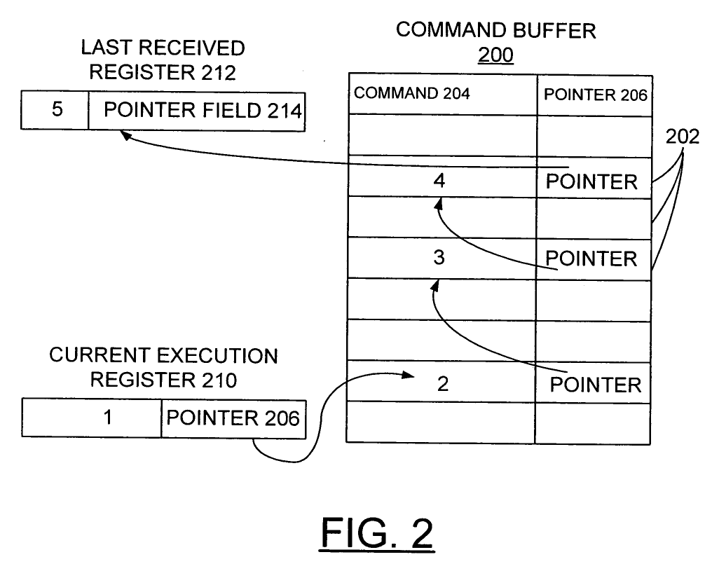

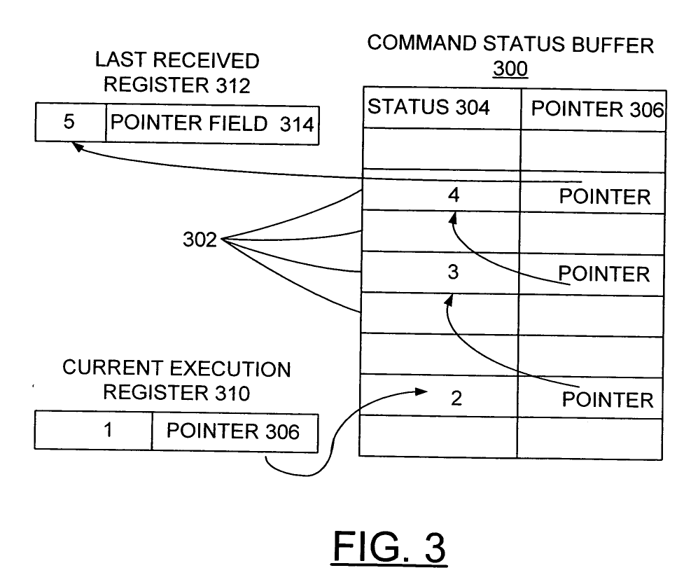

In accordance with features of the invention, commands arrive in one order but must be executed or have their data transferred in a different second order. The second order is set by some transfer ordering event such as receiving a response from a device on the other side of an 10 interconnect, for example, receiving responses sent to the response order block 120 of first chip A, 102 by command processor by the second chip B, 104. The second order is kept using a linked list maintained by hardware, for example, as illustrated and described with respect to FIG. 2 and FIG. 3.

Referring now to FIG. 2, there is shown exemplary apparatus for transfer ordering in the processor input/output (I/O) interface system including a linked list with a command buffer generally designated by the reference character 200 in accordance with the preferred embodiment. Command buffer 200 includes a plurality of entries 202. Each entry 202 includes a respective command 204 and a pointer 206 to the next command that must be executed, or have its data transferred.

Referring also to FIG. 3, alternatively a command status array 300 is a structure kept separately from the command buffer 200 that holds status for each command 204. Command status array 300 includes a plurality of entries 302, each including a respective command status 304 and a linked list pointer 306 to the next command that must be executed, or have its data transferred.

The currently executing command, or command whose data is currently being transferred is held in a current execution register 210 in FIG. 2 or a current execution register 310 in FIG. 3. The current execution register 210, 310 includes the pointer 206, 306 to the next command to be executed, or data to be transferred. When the current command completes, the pointer is used to fetch the next command's information from the command buffer 200 or command status buffer 300.

The command that last received an ordering event is held in a last received register 212 in FIG. 2, or a last received register 312 in FIG. 3. The last received register 212, 312 contains a link pointer field 214, 314, which initially is not valid. When the next ordering event occurs, the link pointer field 214, 314 is loaded with a pointer 206, 306 to the command corresponding to the new ordering event. The register information is then written to the command buffer 200 or command status buffer 300.

The information in this write from last received register 212, 312 includes the respective pointer 206, 306 as well as the indicator that the ordering event for this command 204, 304 has occurred. This means that writing the linked list pointer 206, 306 to the command buffer 200 or command status buffer 300 does not add any extra writes to either of these structures. The write would have occurred anyway to update the status indicator 204, 304. The new command is then saved in the last received register 212, 312.

If the ordering linked list in command buffer 200, or in command status array 300 is empty and the current execution register 210, 310 is empty when an ordering event occurs, the command corresponding to the ordering event is moved directly to the current execution register 210, 310 and no link is created.

The last received register 212, 312 holds the last command information until the next command that must be handled in order is known. When the next command is known, the list pointer 206, 306 in the current execution register 210, 310 is updated and the entire register contents are then written to the command buffer 200, 300.

As shown in FIGS. 2 and 3, a linked list of the preferred embodiment is made up of command buffer location pointers 206, 306 for commands 1, 2, 3, 4, and 5. The linked list pointer 206, 306 points to the next command 204, 304 that must be executed, or have its data transferred, is kept with each command 204, 304 in the command buffer 200, 300.

If the ordering linked list is empty and the current execution register 210, 310 contains a valid command when an ordering event occurs, the command corresponding to the ordering event is stored in the last received register 212, 312. The pointer field 206, 306 in the current execution register 210, 310 is updated to point to the command in the last received register 212, 312.

If the current execution register's pointer 206, 306 is pointing to the command in the last received register 212, 312 when the current execution register's command or data transfer completes, the command from the last received register 212, 312 is moved directly to the current execution register 210, 310.

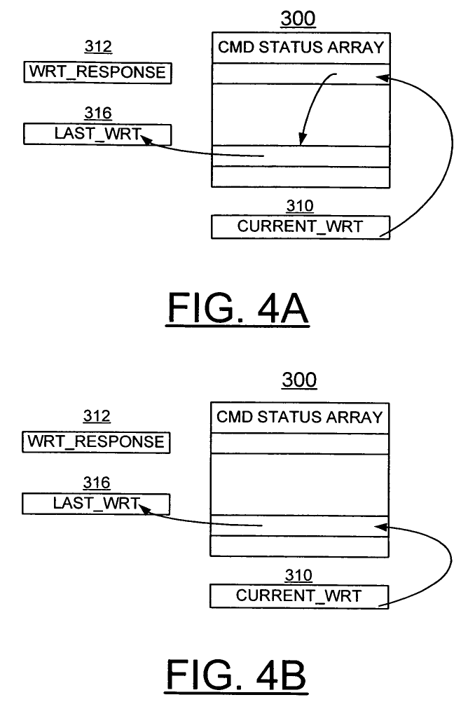

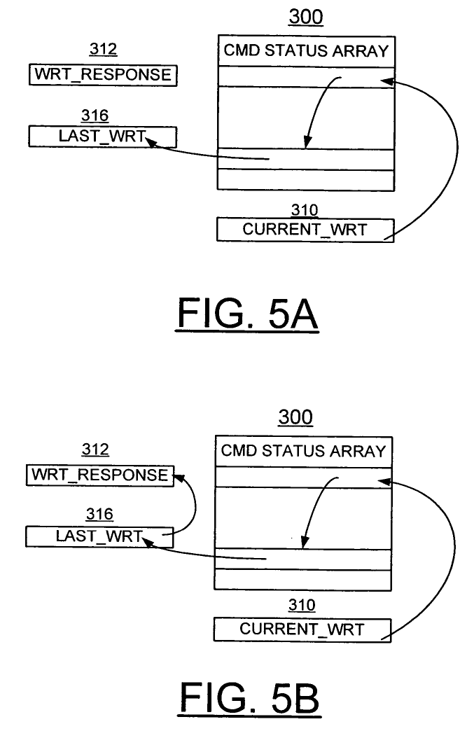

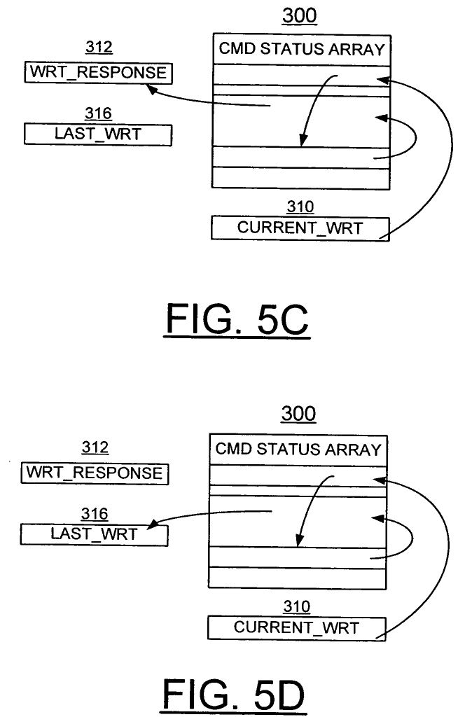

Referring now to FIGS. 4A, 4B and FIGS. 5A, 5B, 5C and 5D exemplary operations of the linked list are shown assuming that write data ordering based upon response order is being implemented and that command status is kept in the command status array 300 separate from the primary command buffer 200.

It should be understood that the illustrated diagrams of FIGS. 4A, 4B and FIGS. 5A, 5B, 5C and 5D would be the same if the command status information were kept in the primary command buffer. In that case the command status array would be replaced with the primary command buffer in the diagrams.

FIGS. 4A and 4B illustrate exemplary operations and changes in the linked list with the command status buffer 300 when a write command data transfer completes in accordance with the preferred embodiment. In FIG. 4A, four write commands chained together in a link list with command 1 in CURRENT_WRT 310, commands 2 and 3 in command status array 300, and command 4 shown in a separate LAST_WRT register 316. FIG. 4B shows three write commands chained together in the link list after one write command data transfer completes. In FIGS. 4A and 4B, the illustrated WRITE_RESPONSE register 312 holds responses that arrive for write commands.

FIGS. 5A, 5B, 5C and 5D are diagrams illustrating exemplary operations and changes in the linked list with the command status buffer of FIG. 3 when responses arrive for write commands, and responses are held in the WRITE_RESPONSE register 312 in accordance with the preferred embodiment. In FIG. 5, four write commands chained together in a link list with command 1 in CURRENT_WRT 310, commands 2 and 3 in command status array 300, and command 4 in LAST_WRT register 316. FIG. 5B shows a new write response ready in the WRITE_RESPONSE register 312, and the pointer is changed in the LAST_WRT register 316 pointing to the WRITE_RESPONSE register 312. FIG. 5C shows moving the LAST_WRT to the command status array 300. FIG. 5D shows moving the WRITE_RESPONSE to the LAST_WRT register 316.

While the present invention has been described with reference to the details of the embodiments of the invention shown in the drawing, these details are not intended to limit the scope of the invention as claimed in the appended claims.

What is claimed is:

1. Apparatus for implementing transfer ordering in a processor input/output (I/O) interface comprising:
a command buffer for storing a plurality of command entries, each command entry for storing a linked list pointer to a next command, and a linked list of commands being chained together by said linked list pointers for defining the transfer ordering;
a current execution register storing a currently executing command;
said current execution register for storing a pointer to the next command to be executed, and said pointer being used to fetch information for the next command when the current command completes; and
a last received register storing a last received command until an ordering event occurs; said last received register for storing a pointer to a command corresponding to the new ordering event when the next ordering event occurs.

2. Apparatus for implementing transfer ordering in a processor input/output (I/O) interface as recited in claim 1 wherein said current execution register further stores a current command having data currently being transferred.

3. Apparatus for implementing transfer ordering in a processor input/output (I/O) interface as recited in claim 1 wherein said current execution register stores a pointer to a next command having data to be transferred.

4. Apparatus for implementing transfer ordering in a processor input/output (I/O) interface as recited in claim 1 wherein information for the last received register is written to the command buffer when the next ordering event occurs.

5. Apparatus for implementing transfer ordering in a processor input/output (I/O) interface as recited in claim 4 wherein the information written includes the linked list pointer to the next command and an indicator that the ordering event for this command has occurred, whereby writing the linked list pointer to the command buffer is provided with a required write to update the status indicator.

6. Apparatus for implementing transfer ordering in a processor input/output (I/O) interface as recited in claim 1 wherein a separate command status buffer is provided; and each said linked list pointer to a next command is stored in said command status buffer.

7. Apparatus for implementing transfer ordering in a processor input/output (I/O) interface as recited in claim 1 wherein the command corresponding to the ordering event is moved directly to the current execution register and no link is created when the ordering linked list is empty and the current execution register is empty when an ordering event occurs.

8. Apparatus for implementing transfer ordering in a processor input/output (I/O) interface as recited in claim 1 wherein the command corresponding to the ordering event is stored in the last received register when the ordering linked list is empty and the current execution register contains a valid command when an ordering event occurs.

9. Apparatus for implementing transfer ordering in a processor input/output (I/O) interface as recited in claim 8 wherein a sequence of operations completed when an ordering event occurs further includes the pointer in the current execution register being updated to point to the command in the last received register.

10. Apparatus for implementing transfer ordering in a processor input/output (I/O) interface as recited in claim 1 wherein the command from the last received register is moved directly to the current execution register when the current command completes and the pointer in the current execution register is pointing to the command in the last received register.

11. A method for implementing transfer ordering in a processor input/output (I/O) interface comprising the step of:
storing a plurality of command entries in a command buffer and storing a linked list pointer to a next command in each stored command entry to chain together a linked list of commands by said linked list pointers for defining the transfer ordering;
storing a currently executing command in a current execution register and storing a pointer to the next command to be executed in said current execution register, and said pointer being used to fetch information for the next command when the current command completes; and
storing a last received command in a last received register until an ordering event occurs; and storing a pointer in said last received register to a command corresponding to the new ordering event when the next ordering event occurs.

12. A method for implementing transfer ordering in a processor input/output (I/O) interface as recited in claim 11 further comprising storing a current command having data currently being transferred in said current execution register.

13. A method for implementing transfer ordering in a processor input/output (I/O) interface as recited in claim 11 further comprising storing a pointer to a next command having data to be transferred in said current execution register.

14. A method for implementing transfer ordering in a processor input/output (I/O) interface as recited in claim 11 further comprising writing information for the last received register to the command buffer when the next ordering event occurs.

15. A method for implementing transfer ordering in a processor input/output (I/O) interface as recited in claim 14 wherein said writing information includes writing the linked list pointer to the next command and writing an indicator that the ordering event for this command has occurred, whereby writing the linked list pointer to the command buffer is provided with a required write to update the status indicator.

16. A method for implementing transfer ordering in a processor input/output (I/O) interface as recited in claim 11 further comprising providing a separate command status buffer for storing command status information; and wherein each said linked list pointer to a next command is stored in said command status buffer.

17. A method for implementing transfer ordering in a processor input/output (I/O) interface as recited in claim 11 further comprising moving the command corresponding to the ordering event directly to the current execution register without creating a link when the ordering linked list is empty and the current execution register is empty when the ordering event occurs.

18. A method for implementing transfer ordering in a processor input/output (I/O) interface as recited in claim 11 further comprising storing the command corresponding to the ordering event in the last received register when the ordering linked list is empty and the current execution register contains a valid command when an ordering event occurs, and updating the pointer in the current execution register to point to the command in the last received register.

19. A method for implementing transfer ordering in a processor input/output (I/O) interface as recited in claim 11 further comprising moving the command from the last received register directly to the current execution register when the current command completes and the pointer in the current execution register is pointing to the command in the last received register.
